(19) United States
(12) Patent Application Publication
(10) Pub. No.: US 2003/0104928 A1
(43) Pub. Date: Jun. 5, 2003

(54) Bridged metallocene catalyst compounds for olefin polymerization

(76) Inventor: Matthew W. Holtcamp, Huffman, TX (US)

Correspondence Address: UNIVATION TECHNOLOGIES LLC, 5555 SAN FELIPE, SUITE 1950, HOUSTON, TX, 77056, US

(21) Appl. No.: 10/304,032

(22) Filed: Nov. 25, 2002

Related U.S. Application Data
(63) Continuation-in-part of application No. 09/747,821, filed on Dec. 22, 2000.

(51) Int. Cl. B01J 31/00; C08F 4/44

(52) U.S. Cl. 502/103; 502/102; 502/117; 526/901; 526/170; 526/943; 526/160; 526/127; 526/348.2; 526/348.3; 526/348.4; 526/348.6

(57) ABSTRACT

Provided is a method of polymerizing olefins and a catalyst system for polymerizing olefins. In one embodiment, the method of polymerizing olefins comprises combining under polymerization conditions an olefin monomer; an activator; and a bridged metallocene compound comprising two Cp groups and a trivalent bridging group (A); the group (A) comprising at least one A moiety and at least three linkages between the A moiety and the two Cp ligands; wherein the Cp groups are independently selected from the group consisting of cyclopentadienyl, tetrahydroindenyl, indenyl, heterocyclic analogues thereof and substituted analogues thereof. An example of the bridged metallocene compound is represented in the structure:

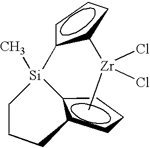

wherein the Cp rings may be substituted as described herein; and the A moiety is silicon in this example. The catalyst system also includes one or more activators, and may also include a support material, wherein the activator and/or the metallocene may be supported on the support material.

### CROSS-REFERENCE TO RELATED APPLICATION

The present application is a Continuation-in-Part of, and claims priority to, U.S. Ser. No. 09/747,821, filed Dec. 22, 2000.

### FIELD OF THE INVENTION

The present invention relates to bridged metallocene catalyst compounds, methods of making these compounds, and a method of polymerizing olefins using bridged metallocene compounds, and more particularly to tri-bound bridged metallocenes and their use as olefin polymerization catalyst components.

### BACKGROUND OF THE INVENTION

One of the advantages of using single-site catalyst components such as metallocenes as part of a catalyst system for olefin polymerization is the ability to tailor the catalyst to fit a particular need. Many aspects of the metallocene catalyst component can be varied—its stereochemistry, steric hindrance, electronic effects, and combinations of these. In controlling these variables, the polymerization activity, as well as the end polymer, can be tailored to suit a variety of needs. Thus, there is great interest in tailoring metallocene catalysts for a variety of needs.

One example of such tailoring is the bridging of the cyclopentadienyl groups of sandwich-type metallocenes. “Sandwich-type” metallocenes, or biscyclopentadienyl metallocenes, are those comprising at least two cyclopentadienyl ligands or ligands isolobal to cyclopentadienyl that are each bound to a metal center such as a Group 3-10 atom, or lanthanide atom. While extensive work has shown the utility of bridged biscyclopentadienyl metallocenes comprising divalent bridging groups (single bond to each cyclopentadienyl ligand), most is directed towards propylene polymerization. Such tailoring has been shown to improve isotacticity in polypropylene, as reviewed by L. Resconi et al., Selectivity in Propene Polymerization with Metallocene Catalysts, 100 CHEM. REV. 1253-1345 (2000).

A more particular class of bridged biscyclopentadienyl metallocenes are tri-bound bridged metallocenes, wherein the bridging group comprises a trivalent group that provides for one bond to one cyclopentadienyl ligand, and two bonds to the other cyclopentadienyl. One such metallocene catalyst component and its use in propylene and ethylene polymerization are described in S. Mansel et al., ansa-Metallocene derivatives XXXII. Zirconocene complexes with a spirosilane bridge: synthesis, crystal structures and properties as olefin polymerization catalysts, 512 J. ORGANOMETALLIC CHEM.225-236 (1996); and in METALORGANIC CATALYSTS FOR SYNTHESIS AND POLYMERIZATION 170-179 (Walter Kaminsky, ed. Springer-Verlag 1999). These particular tri-bound bridged metallocenes tend to show low polymerization activity towards ethylene and propylene, especially at temperatures below about 40 to 50° C. In fact, one tri-bound bridged (Cp-phenyl)(fluorenyl)zirconium compound shows less than 10% the activity towards ethylene homopolymerization at 30° C. relative to its single-bridged analogue. (See R. Werner, Neue C₁-symmetrische Metallocene: Synthese, Charakterisierung und Polymerisationsverhalten (1999) (published Ph.D. Dissertation, Universität Hamburg). What is needed is an improved bridged biscyclopentadienyl metallocene that shows higher activity towards ethylene homopolymerization and copolymerization at a wide range of temperatures, thus offering a wider range of achievable polyolefin product properties.

### SUMMARY OF THE INVENTION

The present invention provides a method of polymerizing olefins, ethylene in particular, and a catalyst system for polymerizing olefins. In one embodiment, the method of polymerizing olefins comprises combining under polymerization conditions a monomer selected from ethylene and C₃ to C₁₀ olefins; an activator; and a bridged metallocene compound comprising two Cp groups and a trivalent bridging group (A); the group (A) comprising at least one A moiety and at least three linkages between the A moiety and the two Cp ligands; wherein the Cp groups are independently selected from the group consisting of cyclopentadienyl, tetrahydroindenyl, indenyl, heterocyclic analogues thereof and substituted analogues thereof. An example of the bridged metallocene compound is represented in the structure:

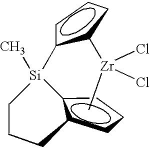

wherein the Cp rings may be substituted as described herein; and the A moiety is silicon in this example. The catalyst system comprises one or more of these bridged metallocenes comprising the trivalent bridging group and one or more activators such as alumoxane, alkylaluminums, tris(pentafluorophenyl)boron (neutral ionizing activators) or tetra(pentafluorophenyl)boron salts (cationic ionizing activators), and may also comprise a support material, wherein the activator and/or the metallocene may be supported on the support material.

### DETAILED DESCRIPTION OF THE INVENTION

General Definitions

As used herein, the phrase “catalyst system” includes at least one “bridged (or “tri-bound bridged”) metallocene catalyst compound” and at least one “activator”, both of which are described further herein. The catalyst system may also include other components, such as supports, etc., and is not limited to the catalyst component and/or activator alone or in combination. The catalyst system may include any number of catalyst compounds in any combination as described herein, as well as any activator in any combination as described herein.

As used herein, the phrase “catalyst compound” includes any compound that, once appropriately activated, is capable of catalyzing the polymerization or oligomerization of olefins, the catalyst compound comprising at least one Group 3 to Group 12 atom or lanthanide atom, and at least one leaving group bound thereto. “Metallocene” catalyst compounds are those comprising at least one cyclopentadienyl group or group isolobal to cyclopentadienyl bound to the metal center.

As used herein, the phrase “leaving group” refers to one or more chemical moieties bound to the metal center of the catalyst compound that can be abstracted from the catalyst component by an activator, thus producing the species active towards olefin polymerization or oligomerization. The activator is described further below.

As used herein, in reference to Periodic Table “Groups” of Elements, the “new” numbering scheme for the Periodic Table Groups are used as in the CRC HANDBOOK OF CHEMISTRY AND PHYSICS (David R. Lide ed., CRC Press 81^{st} ed. 2000).

As used herein, a “hydrocarbyl” includes aliphatic, cyclic, olefinic, acetylenic and aromatic radicals (i.e., hydrocarbon radicals) comprising hydrogen and carbon that are deficient by one hydrogen. A “hydrocarbylene” is deficient by two hydrogens (divalent).

As used herein, an “alkyl” includes linear, branched and cyclic paraffin radicals that are deficient by one hydrogen. Thus, for example, a —CH₃ group (“methyl”) and a CH₃CH₂— group (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups includes phenyl, naphthyl, pyridyl and other radicals whose molecules have the ring structure characteristic of benzene, naphthylene, phenanthrene, anthracene, etc. For example, a C₆H₅⁻ aromatic structure is an “phenyl”, a C₆H₄²⁻ aromatic structure is an “phenylene”. An “arylalkyl” group is an alkyl group having an aryl group pendant therefrom; an “alkylaryl” is an aryl group having one or more alkyl groups pendant therefrom.

As used herein, an “alkylene” includes linear, branched and cyclic hydrocarbon radicals deficient by two hydrogens (i.e., divalent). Thus, —CH₂— (“methylene”) and —CH₂CH₂— or CH₃CH═ (“ethylene”, wherein “═” represents two separate bonds) are examples of alkylene groups. Other groups deficient by two hydrogen radicals include “arylene” and “alkenylene”.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. Non-limiting examples of heteroatom-containing groups include radicals of imines, amines, oxides, phosphines, ethers, ketones, oxoazolines heterocyclics, oxoazolines, thioethers, and the like.

As used herein, an “alkylcarboxylate”, “arylcarboxylate”, and “alkylarylcarboxylate” is an alkyl, aryl, and alkylaryl, respectively, that possesses a carboxyl group in any position. Examples include C₆H₅CH₂C(O)O⁻, CH₃C(O)O⁻, etc.

As used herein, the term “substituted” means that the group following that term possesses at least one moiety in place of one or more hydrogens in any position, the moieties selected from such groups as halogen radicals (esp., Cl, F, Br), hydroxyl groups, carbonyl groups, carboxyl groups, amine groups, phosphine groups, alkoxy groups, phenyl groups, naphthyl groups, C₁ to C₁₀ alkyl groups, C₂ to C₁₀ alkenyl groups, and combinations thereof. Examples of substituted alkyls and aryls includes, but are not limited to, acyl radicals, alkylamino radicals, alkoxy radicals, aryloxy radicals, alkylthio radicals, dialkylamino radicals, alkoxycarbonyl radicals, aryloxycarbonyl radicals, carbamoyl radicals, alkyl- and dialkyl-carbamoyl radicals, acyloxy radicals, acylamino radicals, arylamino radicals, and combinations thereof.

As used herein, structural formulas are employed as is commonly understood in the chemical arts; lines (“—”) used to represent associations between a metal atom (“M”, Group 3 to Group 12 atoms) and a ligand or ligand atom (e.g., cyclopentadienyl, nitrogen, oxygen, halogen ions, alkyl, etc.), as well as the phrases “associated with”, “bonded to” and “bonding”, are not limited to representing a certain type of chemical bond, as these lines and phrases are meant to represent a “chemical bond”; a “chemical bond” defined as an attractive force between atoms that is strong enough to permit the combined aggregate to function as a unit, or “compound”.

A certain stereochemistry for a given structure or part of a structure should not be implied unless so stated for a given structure or apparent by use of commonly used bonding symbols such as by dashed lines and/or heavy lines.

Unless stated otherwise, no embodiment of the present invention is herein limited to the oxidation state of the metal atom “M” as defined below in the individual descriptions and examples that follow.

Tri-Bound Bridged Metallocene Catalyst Compound

The catalyst system of the present invention includes at least one tri-bound bridged metallocene catalyst compound as described herein. The invention also includes the tri-bound bridged metallocene compound itself. Metallocene catalyst compounds are generally described throughout in, for example, 1 & 2 METALLOCENE-BASED POLYOLEFINS (John Scheirs & W. Kaminsky eds., John Wiley & Sons, Ltd. 2000). The tri-bound bridged metallocene catalyst compounds as described herein include full “sandwich” compounds having at least two Cp (cyclopentadienyl and ligands isolobal to cyclopentadienyl) ligands bound to at least one Group 3 to Group 12 metal atom or lanthanide atom, and include one or more leaving group(s) bound to the at least one metal atom, depending upon the nature of the metal atom. The tri-bound bridged metallocenes described herein further include a trivalent bridging group bridging the at least two Cp ligands. Hereinafter, the metallocene catalyst compound of the present invention is referred to as a “bridged” or “tri-bound bridged” metallocene catalyst compound.

The Cp ligands are typically π-bonded and/or fused ring(s) or ring systems. The ring(s) or ring system(s) typically comprise atoms selected from Groups 13 to 16 atoms, and more particularly, the atoms that make up the Cp ligands are selected from carbon, nitrogen, oxygen, silicon, sulfur, phosphorous, germanium, boron and aluminum and a combination thereof. Even more particularly, the Cp ligand(s) are selected from substituted and unsubstituted cyclopentadienyl ligands and ligands isolobal to cyclopentadienyl (including heterocyclic analogues), non-limiting examples of which include cyclopentadienyl, indenyl, fluorenyl, tetrahydroindenyl and their heterocyclic analogs.

The metal atom “M” of the metallocene catalyst compound, as described throughout the specification and claims, may be selected from Groups 3 through 12 atoms and lanthanide atoms in one embodiment; and selected from Groups 3 through 10 atoms in a more particular embodiment, and selected from Sc, Ti, Zr, Hf, Cr, V, Nb, Ta, Mn, Re, Fe, Ru, Os, Co, Rh, Ir, and Ni in yet a more particular embodiment; and selected from Groups 4, 5 and 6 atoms in yet a more particular embodiment, and selected from Ti, Zr, and Hf atoms in yet a more particular embodiment, and selected from Zr and Hf in yet a more particular embodiment. The Cp ligand(s) form at least one chemical bond with the metal atom M to form the bridged metallocene catalyst compound. The Cp ligands are distinct from the leaving groups bound to the catalyst compound in that they are not highly susceptible to substitution/abstraction reactions.

In one aspect of the invention, the one or more tri-bound bridged metallocene catalyst compounds of the invention are represented by the formula (I):

Cp^{A}(A)Cp^{B}MXₙ (I)

wherein M is defined above; where each X (a leaving group) and each Cp is chemically bonded to M; and wherein the metallocene catalyst compound of the present invention comprises a trivalent bridging group (A) that comprises at least one A moiety and at least three “linkages”: at least two linkages between the A moiety and one of Cp^{A} or Cp^{B}, and one linkage between the A moiety and the other Cp ligand, the “linkages” selected independently from covalent bonds, C₁ to C₁₂ hydrocarbylenes and C₁ to C₁₂ heteroatom-containing hydrocarbylenes.

The ligands represented by Cp^{A} and Cp^{B} in formula (I) may be the same or different cyclopentadienyl ligands or ligands isolobal to cyclopentadienyl, either or both of which may contain heteroatoms and ether or both of which may be substituted by a group R. Non-limiting examples of such ligands include cyclopentadienyl, cyclopentaphenanthreneyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄Ind”), substituted versions thereof, and heterocyclic versions thereof. In one embodiment, Cp^{A} and Cp^{B} are independently selected from the group consisting of cyclopentadienyl, indenyl, tetrahydroindenyl, fluorenyl, and substituted derivatives of each.

Independently, each Cp^{A} and Cp^{B} of formula (I) may be unsubstituted or substituted with any one or combination of substituent groups R. Non-limiting examples of substituent groups R include groups selected from hydrogen radical, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbonyls, alkyl- and dialkyl-carbamoyls, acyloxys, acylaminos, aroylaminos, and combinations thereof.

More particular non-limiting examples of substituents R bound to the Cp ligands include methyl, ethyl, propyl, butyl, pentyl, hexyl, cyclopentyl, cyclohexyl, benzyl, phenyl, methylphenyl, and tert-butylphenyl groups and the like, including all their isomers, for example tert-butyl, isopropyl, and the like. Other possible R groups include substituted alkyls and aryls such as, for example, fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)silyl, methylbis(difluoromethyl)silyl, bromomethyldimethylgermyl and the like; and disubstituted boron radicals including dimethylboron for example; and disubstituted Group 15 radicals including dimethylamine, dimethylphosphine, diphenylamine, methylphenylphosphine, Group 16 radicals including methoxy, ethoxy, propoxy, phenoxy, methylsulfide and ethylsulfide. Other R substituents include olefins such as olefinically unsaturated substituents including vinyl-terminated ligands, for example 3-butenyl, 2-propenyl, 5-hexenyl and the like. In one embodiment, at least two R groups, two adjacent R groups more particularly, are joined to form a ring structure having from 3 to 20 atoms selected from carbon, nitrogen, oxygen, phosphorous, silicon, germanium, aluminum, boron and combinations thereof. Also, a substituent group R group such as 1-butanyl may form a bonding association to the element M.

The one or more X groups in formula (I) are any desirable leaving groups in one embodiment. The value for n is an integer from 0 to 4 in one embodiment, and 0, 1 or 2 in a more particular embodiment. Non-limiting examples of X groups in formula (I) include amines, phosphines, ethers, carboxylates, dienes, hydrocarbon radicals having from 1 to 20 carbon atoms, fluorinated hydrocarbon radicals (e.g., —C₆F₅ (pentafluorophenyl)), fluorinated alkylcarboxylates (e.g., CF₃C(O)O⁻), hydrides and halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In one embodiment, two or more X's form a part of a fused ring or ring system.

The A moiety in formulas/structures (I) to (IV) is any moiety that provides, or is capable of providing, at least three valences or “bridging-bond positions” between at least two Cp ligands. Non-limiting examples of A include Group 13, Group 14 or Group 15 atoms, trivalent hydrocarbons (e.g., trivalent cyclohexane, or C₆H₉³⁻), and trivalent heteroatom-containing hydrocarbons (e.g., trivalent piperidine, or C₅H₁₁N³⁻); and in a more particular embodiment, A is selected from the group consisting of boron, aluminum, carbon, silicon, tin, nitrogen, phosphorous, trivalent C₂ to C₁₀ hydrocarbons, and trivalent C₂ to C₁₀ heteroatom-containing hydrocarbons.

In yet a more particular embodiment, A is a Group 13, Group 14, or Group 15 atom. In yet a more particular embodiment, the A moiety is selected from the group consisting of boron, aluminum, carbon, silicon, germanium, nitrogen, and phosphorous; and selected from the group consisting of carbon and silicon in yet a more particular embodiment; and is silicon in yet a more particular embodiment. As a proviso, if A is a Group 14 atom, A is chemically bound to a fourth group selected from: hydride, halogen ion, C₁ to C₆ alkyl, C₆ to C₁₂ aryl, C₇ to C₁₅ alkylaryl and C₁ to C₆ heteroatom-containing hydrocarbyls in one embodiment; and hydride, methyl, ethyl, phenyl, benzyl, chloride ion, and bromide ion in a more particular embodiment.

The “linkages” from A to the Cp ligands are independently selected from: chemical bonds, C₁ to C₁₂ alkylenes, C₃ to C₁₀ cycloalkylenes, C₂ to C₁₀ alkenylenes, C₁ to C]₂ heteroatom-containing hydrocarbylenes in one embodiment; chemical bonds, C₁ to C₆ alkylenes, C₄ to C₆ cycloalkylenes, C₂ to C₆ alkenylenes, C₁ to C₆ heteroatom-containing hydrocarbylenes in a more particular embodiment; and chemical bonds, methylene, ethylene, propylene, butylene, pentylene, and hexylene in yet a more particular embodiment. In the case of the heteroatom-containing hydrocarbylenes, the heteroatoms are selected from Group 13 to Group 16 atoms in one embodiment, and oxygen, boron, nitrogen, sulfur, phosphorous and aluminum in another embodiment.

In a particular embodiment of the trivalent bridging group (A), one linkage between the A moiety and Cp^{A} is selected from a chemical bond and methylene; and the other two linkages that are bound to the Cp^{B} are selected from a chemical bond, ethylene, propylene, butylene, pentylene, and hexylene.

The tri-bound bridged metallocene of the present invention can be described more particularly in the structure (II) below:

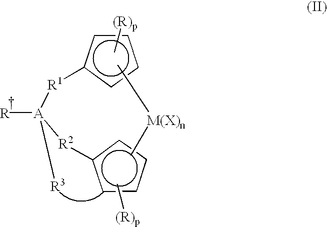

wherein M as defined above;

A is: selected from Group 13 to Group 15 atoms in one embodiment; selected from the group consisting of boron, aluminum, carbon, silicon, germanium, tin, nitrogen, and phosphorous in a more particular embodiment; selected from the group consisting of carbon and silicon in yet a more particular embodiment; and is silicon in yet a more particular embodiment;

R^{\} selected from: hydride, halogen ion, C₁ to C₆ alkyl, C₆ to C₁₂ aryl, C₇ to C₁₅ alkylaryl and C₁ to C₆ heteroatom-containing hydrocarbyls; and hydride, methyl, ethyl, phenyl, benzyl, chloride ion, and bromide ion in a more particular embodiment; with the proviso that if A is a Group 13 or Group 15 atom (or other group that forms only three bonds with other moieties), then R^{†} is absent;

R¹, R² and R³ are divalent groups independently selected from: a chemical bond, C₁ to C₆ alkylenes, C₄ to C₆ cycloalkylenes, C₂ to C₈ alkenylenes, C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment;

wherein in a particular embodiment, R¹, R² are selected from a chemical bond and methylene and R³ is selected from ethylene, propylene, butylene, pentylene, and hexylene;

each R (structure (II)) represents a substitution of a hydrogen with a group independently selected from halogen radicals, C₁ to C₆ alkyls, C₆ to C₁₂ aryls, and C₁ to C₆ heteroatom-containing hydrocarbyls; wherein adjacent R groups may be C₂ to C₆ hydrocarbylene groups bound together to form one or more 4 to 8 member rings, either saturated, partially saturated, or aromatic, thus, together with the cyclopentadienyl ring, forming, for example, indenyl, tetrahydroindenyl, fluorenyl, which may be substituted by groups as defined above for R;

p is an integer from 0 to 4;

each X is independently selected from: any leaving group in one embodiment; and more particularly, selected from halogen ions, hydride, C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₁₈ alkylaryloxys, C₁ to C₁₂ fluoroalkyls, C₆ to C₁₂ fluoroaryls, and C₁ to C₁₂ heteroatom-containing hydrocarbons and substituted derivatives thereof; hydride, halogen ions, C₁ to C₆ alkyls, C₂ to C₆ alkenyls, C₇ to C₁₈ alkylaryls, C₁ to C₆ alkoxys, C₆ to C₁₄ aryloxys, C₇ to C₁₆ alkylaryloxys, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls, and C₇ to C₁₈ fluoroalkylaryls in yet a more particular embodiment; hydride, methyl, phenyl, phenoxy, benzoxy, tosyl, fluoromethyls and fluorophenyls in yet a more particular embodiment; C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls and C₁ to C₁₂ heteroatom-containing alkyls, C₁ to C₁₂ heteroatom-containing aryls and C₁ to C₁₂ heteroatom-containing alkylaryls in yet a more particular embodiment; hydride, halogens ions, C₁ to C₆ alkyls, C₂ to C₆ alkenyls, C₇ to C₁₈ alkylaryls, halogenated C₁ to C₆ alkyls, halogenated C₂ to C₆ alkenyls, and halogenated C₇ to C₁₈ alkylaryls in yet a more particular embodiment; and fluoride, chloride, bromide, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls) in yet a more particular embodiment; and

wherein n is an integer from 0 to 4; and an integer from 1 to 2 in a more particular embodiment.

A particular embodiment of the tri-bound bridged metallocene catalyst compound of the invention is described in structures (IIIa) and (IIIb):

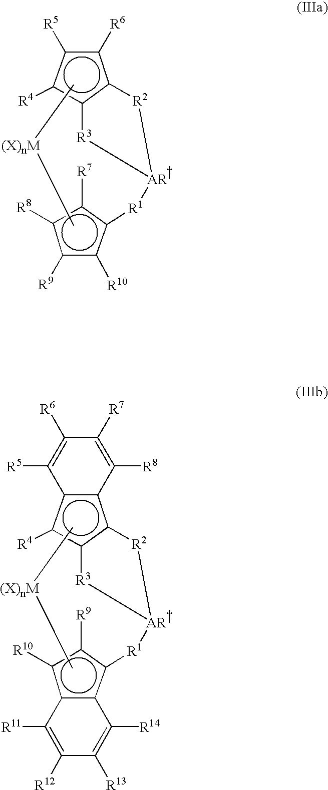

wherein M, X, n, and A are defined above; R⁴, R⁵, R⁶, R⁷, R⁸, R⁹, R¹⁰, R¹¹, R¹², R¹³, and R¹⁴ are groups independently selected from hydrogen radical, halogen radicals, C₁ to C₁₂ alkyls, C₂ to C₁₂ alkenyls, C₆ to C₁₂ aryls, C₇ to C₂₀ alkylaryls C₁ to C₁₂ alkoxys, C₁ to C₁₂ fluoroalkyls, C₆ to C₁₂ fluoroaryls, and C₁ to C₁₂ heteroatom-containing hydrocarbons and substituted derivatives thereof in one embodiment; selected from hydrogen radical, fluorine radical, chlorine radical, bromine radical, C₁ to C₆ alkyls, C₂ to C₆ alkenyls, C₇ to C₁₈ alkylaryls, C₁ to C₆ fluoroalkyls, C₂ to C₆ fluoroalkenyls, C₇ to C₁₈ fluoroalkylaryls in a more particular embodiment; and hydrogen radical, fluorine radical, chlorine radical, methyl, ethyl, propyl, isopropyl, butyl, isobutyl, tert-butyl, hexyl, phenyl, 2,6-dimethylphenyl, and 4-tert-butylphenyl groups in yet a more particular embodiment; and R^{†}, when present, is selected from: hydride, halogen ion, C₁ to C₆ alkyl, C₆ to C₁₂ aryl, C₇ to C₁₅ alkylaryl and C₁ to C₆ heteroatom-containing hydrocarbyls; and hydride, methyl, ethyl, phenyl, benzyl, chloride ion, and bromide ion in a more particular embodiment; provided that R^{†} is absent if A is a Group 13 or 15 atom.

In a particular embodiment of heteroatom-containing hydrocarbons as described herein, the heteroatoms are selected from boron, aluminum, silicon, nitrogen, phosphorous, oxygen and sulfur; and in a more particular embodiment, the heteroatom-containing hydrocarbons contain from 1 to 3 heteroatoms selected from these atoms.

Described more particularly, the trivalent bridging group (A) comprising at least one A moiety and at least three linkages between the A moiety and the two Cp ligands can be described in structure (IV):

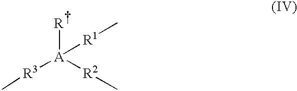

wherein A is a Group 14 atom, and a silicon or carbon in a particular embodiment;

R^{†} is selected from hydride, halogen radicals, C₁ to C₆ alkyls, C₆ to C₁₂ aryls, and C₁ to C₆ heteroatom-containing hydrocarbons; and selected from hydride, methyl and phenyl in yet a more particular embodiment;

R¹ is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and selected from a chemical bond and methylene in yet a more particular embodiment;

R² is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and selected from a chemical bond and methylene in yet a more particular embodiment; and

R³ is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and methylene, ethylene, propylene and butylene in yet a more particular embodiment.

In one embodiment of the bridging group of (IV), the R¹ group is bound to one Cp of the bridged metallocene compound of the invention, and the R² and R³ groups are bound to another Cp of the bridged metallocene compound of the invention. The R¹, R² and R³ groups can be bound to any position along the Cp ring structure, directly bonding with one carbon each of the ring in place of a hydrogen. In one embodiment, R² and R³ are bound to adjacent carbon atoms, and in another embodiment, the R² and R³ groups are bound to a first and third carbon (one carbon therebetween), respectively. In yet another embodiment, the R² and R³ groups are bound to a first and fourth carbon (two carbons therebetween), respectively.

Non-limiting examples of the trivalent bridging groups comprising A and at least three linkages include methylsilanetriyl, methylsilanetriylmethylene, methylsilanetriylethylene, methylsilanetriyl(n-propylene), methylsilanetriyl(n-butylene), methylsilanetriyl(n-pentylene), methylsilanetriyl(n-hexylene), methylsilanetriyl(n-cyclohexylene), methylsilanetriyldimethylene, methylsilanetriyl(methylene)ethylene, methylsilanetriyl(methylene)(n-propylene), methylsilanetriyl(methylene)(n-butylene), methylsilanetriyl(methylene)(n-pentylene), methylsilanetriyl(methylene)(n-hexylene), methylsilanetriyl(methylene)(n-cyclohexylene), methylcarbyl, methylcarbylmethylene, methylcarbylethylene, methylcarbyl(n-propylene), methylcarbyl(n-butylene), methylcarbyl(n-pentylene), methylcarbyl(n-hexylene), methylcarbyl(n-cyclohexylene), methylcarbyldimethylene, methylcarbyl(methylene)ethylene, methylcarbyl(methylene)(n-propylene), methylcarbyl(methylene)(n-butylene), methylcarbyl(methylene)(n-pentylene), methylcarbyl(methylene)(n-hexylene), and methylcarbyl(methylene)(n-cyclohexylene); wherein “silanetriyl” and “carbyl” are the trivalent Si and C groups, respectively, and the divalent group in parenthesis is the linking group bound to the silanetriyl or carbyl at one valent position, the other valent position open for bonding to a cyclopentadienyl carbon.

Other non-limiting examples of trivalent bridging groups comprising A and at least three linkages include azanetriyl, azanetriyl(methylene), azanetriyl(dimethylene), azanetriyl(trimethylene), azanetriyl(ethylene), azanetriyl(n-propylene), azanetriyl(n-butylene), azanetriyl(n-pentylene), azanetriyl(methylene)(ethylene), azanetriyl(methylene)(n-propylene), azanetriyl(methylene)(n-butylene), azanetriyl(methylene)(n-pentylene), phosphorous analogs thereof, and the like; wherein “azanetriyl” is the trivalent N, and the divalent group in parenthesis is the linking group bound to the silanetriyl or carbyl at one valent position, the other valent position open for bonding to a cyclopentadienyl carbon.

The bridged metallocene catalyst component of the invention, as well as the catalyst system of the invention comprising the bridged metallocene catalyst component, can be described by any combination of any embodiment described herein.

Synthesis of the Tri-Bound Bridged Metallocenes

The tri-bound bridged Cps used to form the metallocenes of the present invention are synthesized, in one embodiment, by contacting, under desirable conditions, the desired Cp-salts with the desired bridged structure (“linking reagent”) comprising three dissociable groups (e.g., Br, Cl, etc.) in a polar solvent such as an ether. This is typically a two step process, wherein two linkages are formed in the first step, followed by the formation of the third linkage in the second step. The reaction can be represented by the following scheme (a):

R^{†}A(R¹E)(R²E)(R³E)+Y Cp^{A-}+Z Cp^{B-}→Cp^{A}(A)Cp^{A} or Cp^{A}(A)Cp^{B} (a)

wherein R^{†}A(R¹E)(R²E)(R³E) is the linking reagent that forms the trivalent bridging group (A);

wherein A is: selected from Group 13 to Group 15 atoms in one embodiment; selected from the group consisting of boron, aluminum, carbon, silicon, germanium, tin, nitrogen, and phosphorous in a more particular embodiment; selected from the group consisting of carbon and silicon in yet a more particular embodiment; and is silicon in yet a more particular embodiment;

R^{†} is selected from hydride, halogen radicals, C₁ to C₆ alkyls, C₆ to C₁₂ aryls, and C₁ to C₆ heteroatom-containing hydrocarbons; and selected from hydride, methyl and phenyl in yet a more particular embodiment; provided that R^{†} is absent when A is a Group 13 or 15 atom;

R¹ is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and selected from a chemical bond and methylene in yet a more particular embodiment;

R² is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and selected from a chemical bond and methylene in yet a more particular embodiment;

R³ is a divalent group selected from: a chemical bond, C₁ to C₆ alkylenes, C₄ to C₆ cycloalkylenes, C₂ to C₈ alkenylenes, and C₁ to C₆ heteroatom-containing hydrocarbylenes in one embodiment; a chemical bond, methylene, ethylene, propylene, butylene, pentylene, hexylene, cyclopentylene and cyclohexylene in a more particular embodiment; and methylene, ethylene, propylene and butylene in yet a more particular embodiment;

each E is bound to each of R¹, R² and R³, and each E is independently selected from any abstractable or substitution-labile group; and selected from silyl groups, chlorine, bromine and iodine in one embodiment; and

each of Cp^{A-} and Cp^{B-} are Cp salts independently selected from cyclopentadienyl ligands or ligands isolobal to cyclopentadienyl, either or both of which may contain heteroatoms and ether or both of which may be substituted by a group R. Non-limiting examples of such ligands include cyclopentadienyl, cyclopentaphenanthreneyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄Ind”), substituted versions thereof, and heterocyclic versions thereof In one embodiment, Cp^{A-} and Cp^{B-} salts are independently selected from the group consisting of cyclopentadienyl, indenyl, tetrahydroindenyl, fluorenyl, and substituted derivatives of each; and in a more particular embodiment, the Cps are independently selected from cyclopentadienyl, tetrahydroindenyl, indenyl, heterocyclic analogues thereof, and substituted analogues thereof.

In reaction scheme (a), the number of equivalents of the desired Cps is represented by Y and Z, both of which can independently be any number, including fractional numbers, between 4 and 0, wherein Y+Z is between 2 and 4, inclusive. In a particular embodiment, for every equivalent of bridging group R^{†}A(R¹E)(R²E)(R³E) there is added from 2 to 3 equivalents of Cp salts. In one embodiment, Y is 3 and Z is 0.

Non-limiting examples of the linking reagent R^{†}A(R¹E)(R²E)(R³E) include ClCH₂SiCl₂(CH₃); ClCH₂CH₂SiCl₂(CH₃); ClCH₂CH₂CH₂SiCl₂(CH₃); ClCH₂CH₂CH₂CH₂SiCl₂(CH₃); ClCH₂CH₂CH₂SiCl(CH₃)(CH₂Cl); ClCH₂CH₂CH₂SiCl(CH₃)(CH₂CH₂Cl), ClCH₂CH₂CH₂SiCl₂(C₆H₅); ClCH₂CH₂CH₂SiCl(C₆H₅)(CH₂Cl); ClCH₂CCl₂(CH₃); ClCH₂CH₂CCl₂(CH₃); ClCH₂CH₂CH₂CCl₂(CH₃); ClCH₂CH₂CH₂CH₂CCl₂(CH₃); ClCH₂CH₂CH₂CCl(CH₃)(CH₂Cl); ClCH₂CH₂CH₂CCl(CH₃)(CH₂CH₂Cl); ClCH₂CH₂CH₂CCl₂(C₆H₅); ClCH₂CH₂CH₂CCl(C₆H₅)(CH₂Cl); and derivatives thereof. By “derivatives thereof”, it is meant any of these compounds wherein the Cl is a Br or other highly dissociable moiety, and wherein any hydrogen is substituted with a C₁ to C₆ alkyl or C₆ aryl or C₆ heteroatom containing aryl.

The reaction represented in (a) is carried out in a liquid diluent selected from polar diluents that are liquid at the reaction temperature. Examples of desirable diluents include ethers, ketones, polar halogenated hydrocarbons, and other polar diluents. The reaction temperature ranged from −50° C. to 50° C. in one embodiment, and from −40° C. to 30° C. in a particular embodiment. First, the Cp salts are combined with the R^{†}A(R¹E)(R²E)(R³E) linking reagent, wherein two of the dissociable groups E are replaced by one Cp each.

Next, one equivalent of a strong base such as n-butyl lithium is added to the ligand to deprotonated one of the Cp rings, thus facilitating formation of the third bridge group. The reaction represented in (a) may optionally be carried out in a two stage process, wherein in the first stage the reactants are contacted in the polar solvent such as diethyl ether, and stirred for 8 to 20 hrs, followed by addition of another polar solvent such as tetrahydrofuran in a second stage, wherein the ether is optionally removed from the first reaction product. The one equivalent of a strong base such as n-butyl lithium is then added to this second mixture and reacted at a temperature between 0° C. to 100° C. for 5 to 12 hrs, and reacted at a temperature between 30° C. to 70° C. in another embodiment. In any case, the reaction product from the one or two step synthesis is isolated by removing the diluent, resulting in the tri-bound bridged ligands Cp^{A}(A)cp^{A} or Cp^{A}(A)Cp^{B}.

The resultant tri-bound bridged ligands can then be reacted with a desirable Group 4, 5 or 6 metal salt such as, for example, HfCl₄ or Zr(N(CH₃)₂)₄ in a non-polar diluent such as a hydrocarbon diluent (e.g., hexane, toluene, etc.) to form a metallocene. The identity of the metal may vary depending upon the metal salt added, as well as the identity of the leaving group X. This can be altered in the final product by techniques known in the art.

More particularly, the reaction in (a) may be represented by the two step scheme (b) and (c) below:

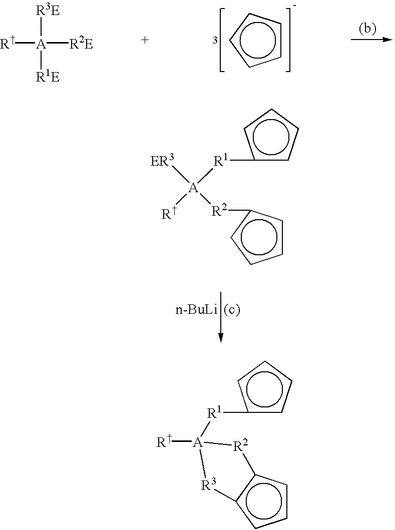

wherein each Cp may be the same or different and selected from cyclopentadienyl and ligands isolobal to cyclopentadienyl, and selected from indenyl, tetrahydroindenyl, cyclopentadienyl, substituted analogues thereof and heterocyclic analogues thereof. The Cps may be substituted by any group such as described for R⁴ through R¹⁴ above (III). In a desirable embodiment, E is chlorine or bromine. Each of R¹ though R³ are as defined above. Both steps (b) and (c) are desirably carried out in a polar diluent such as diethyl ether and/or tetrahydrofuran. The Cp salt is a salt such as, for example, sodium cyclopentadienyl or lithium indenide. In a particular embodiment, A is selected from silicon and carbon.

Activators

The catalyst system useful in preparing polyolefin polymers of the invention includes at least one tri-bound bridged metallocene catalyst component, and at least one activator. As used herein, the term “activator” is defined to be any compound or combination of compounds, supported or unsupported, which can activate a single-site catalyst compound (e.g., metallocenes, Group 15-containing catalysts, etc.), such as by creating a cationic species from the catalyst component. Typically, this involves the abstraction of at least one leaving group (X group in the formulas/structures above) from the metal center of the catalyst component. The catalyst components of the present invention are thus activated towards olefin polymerization using such activators. Embodiments of such activators include Lewis acids such as cyclic or oligomeric poly(hydrocarbylaluminum oxides) and so called non-coordinating ionic activators (“NCA”) (alternately, “ionizing activators” or “stoichiometric activators”), or any other compound that can convert a neutral metallocene catalyst component to a metallocene cation that is active with respect to olefin polymerization.

More particularly, it is within the scope of this invention to use Lewis acids such as alumoxane (e.g., “MAO”), modified alumoxane (e.g., “TIBAO”), and alkylaluminum compounds as activators, and/or ionizing activators (neutral or ionic) such as tri (n-butyl)ammonium tetrakis(pentafluorophenyl)boron and/or a trisperfluorophenyl boron metalloid precursors to activate desirable metallocenes described herein. MAO and other aluminum-based activators are well known in the art. Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). The activators may be associated with or bound to a support, either in association with the catalyst component (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Non-limiting examples of aluminum alkyl compounds which may be utilized as activators for the catalyst precursor compounds for use in the methods of the present invention include trimethylaluminum, triethylaluminum, triisobutylaluminum, tri-n-hexylaluminum, tri-n-octylaluminum and the like.

Examples of neutral ionizing activators include Group 13 tri-substituted compounds, in particular, tri-substituted boron, tellurium, aluminum, gallium and indium compounds, and mixtures thereof. The three substituent groups are each independently selected from alkyls, alkenyls, halogen, substituted alkyls, aryls, arylhalides (esp. fluoroaryls), alkoxy and halides. In one embodiment, the three groups are independently selected from halogen, mono or multicyclic (including halosubstituted) aryls, alkyls, and alkenyl compounds and mixtures thereof In another embodiment, the three groups are selected from alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls), and combinations thereof. In yet another embodiment, the three groups are selected from alkyls having 1 to 4 carbon groups, phenyl, naphthyl and mixtures thereof. In yet another embodiment, the three groups are selected from highly halogenated alkyls having 1 to 4 carbon groups, highly halogenated phenyls, and highly halogenated naphthyls and mixtures thereof. By “highly halogenated”, it is meant that at least 50% of the hydrogens are replaced by a halogen group selected from fluorine, chlorine and bromine. In yet another embodiment, the neutral stoichiometric activator is a tri-substituted Group 13 compound comprising highly fluorided aryl groups, the groups being highly fluorided phenyl and highly fluorided naphthyl groups.

In another embodiment, the neutral tri-substituted Group 13 compounds are boron compounds such as a trisperfluorophenyl boron, trisperfluoronaphthylboron, tris(3,5-di(trifluoromethyl)phenyl)boron, tris(di-t-butylmethylsilyl)perfluorophenylboron, and other highly fluorinated trisarylboron compounds and combinations thereof, and their aluminum equivalents. Other suitable neutral ionizing activators are described in U.S. Pat. No. 6,399,532 B1, U.S. Pat. No. 6,268,445 B1, and in 19 ORGANOMETALLICS 3332-3337 (2000), and in 17 ORGANOMETALLICS 3996-4003 (1998).

Illustrative, not limiting examples of ionic ionizing activators include trialkyl-substituted ammonium salts such as triethylammoniumtetra(phenyl)boron, tripropylammoniumtetra(phenyl)boron, tri(n-butyl)ammoniumtetra(phenyl)boron, trimethylammoniumtetra(p-tolyl)boron, trimethylammoniumtetra(o-tolyl)boron, tributylammoniumtetra(pentafluorophenyl)boron, tripropylammoniumtetra(o,p-dimethylphenyl)boron, tributylammoniumtetra(m,m-dimethylphenyl)boron, tributylammoniumtetra(p-tri-fluoromethylphenyl)boron, tributylammoniumtetra(pentafluorophenyl)boron, tri(n-butyl)ammonium tetra(o-tolyl)boron and the like; N,N-dialkyl anilinium salts such as N,N-dimethylaniliniumtetra(phenyl)boron, N,N-diethylaniliniumtetra(phenyl)boron, N,N-2,4,6-pentamethylaniliniumtetra(phenyl)boron and the like; dialkyl ammonium salts such as di-(isopropyl)ammonium tetra(pentafluorophenyl)boron, dicyclohexylammoniumtetra(phenyl)boron and the like; and triaryl phosphonium salts such as triphenylphosphoniumtetra(phenyl)boron, tri(methylphenyl)phosphoniumtetra(phenyl)boron, tri(dimethylphenyl)phosphoniumtetra(phenyl)boron and the like, and their aluminum equivalents.

In yet another embodiment of the activator of the invention, an alkylaluminum can be used in conjunction with a heterocyclic compound. The ring of the heterocyclic compound may includes at least one nitrogen, oxygen, and/or sulfur atom, and includes at least one nitrogen atom in one embodiment. The heterocyclic compound includes 4 or more ring members in one embodiment, and 5 or more ring members in another embodiment.

The heterocyclic compound for use as an activator with an alkylaluminum may be unsubstituted or substituted with one or a combination of substituent groups. Examples of suitable substituents include halogen, alkyl, alkenyl or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals, or any combination thereof. The substituents groups may also be substituted with halogens, particularly fluorine or bromine, or heteroatoms or the like.

Non-limiting examples of hydrocarbon substituents include methyl, ethyl, propyl, butyl, pentyl, hexyl, cyclopentyl, cyclohexyl, benzyl or phenyl groups and the like, including all their isomers, for example tertiary butyl, isopropyl, and the like. Other examples of substituents include fluoromethyl, fluoroethyl, difluoroethyl, iodopropyl, bromohexyl or chlorobenzyl.

In one embodiment, the heterocyclic compound is unsubstituted. In another embodiment one or more positions on the heterocyclic compound are substituted with a halogen atom or a halogen atom containing group, for example a halogenated aryl group. In one embodiment the halogen is selected from chlorine, bromine and fluorine, and selected from fluorine and bromine in another embodiment, and the halogen is fluorine in yet another embodiment.

Non-limiting examples of heterocyclic compounds utilized in the activator of the invention include substituted and unsubstituted pyrroles, imidazoles, pyrazoles, pyrrolines, pyrrolidines, purines, carbazoles, and indoles, phenyl indoles, 2,5-dimethyl pyrroles, 3-pentafluorophenyl pyrrole, 4,5,6,7-tetrafluoroindole or 3,4-difluoropyrroles.

In one embodiment, the heterocyclic compound described above is combined with an alkyl aluminum or an alumoxane to yield an activator compound which, upon reaction with a catalyst component, for example a metallocene, produces an active polymerization catalyst. Non-limiting examples of alkylaluminums include trimethylaluminum, triethylaluminum, triisobutylaluminum, tri-n-hexylaluminum, tri-n-octylaluminum, tri-iso-octylaluminum, triphenylaluminum, and combinations thereof.

Other activators include those described in WO 98/07515 such as tris(2,2′,2″-nonafluorobiphenyl)fluoroaluminate. Combinations of activators are also contemplated by the invention, for example, alumoxanes and ionizing activators in combinations. Other activators include aluminum/boron complexes, perchlorates, periodates and iodates including their hydrates; lithium (2,2′-bisphenyl-ditrimethylsilicate)4THF; silylium salts in combination with a non-coordinating compatible anion. Also, methods of activation such as using radiation, electro-chemical oxidation, and the like are also contemplated as activating methods for the purposes of rendering the neutral bulky ligand metallocene-type catalyst compound or precursor to a bulky ligand metallocene-type cation capable of polymerizing olefins. Other activators or methods for activating a bulky ligand metallocene-type catalyst compound are described in for example, U.S. Pat. Nos. 5,849,852, 5,859,653 and 5,869,723 and WO 98/32775.

In general, the activator and catalyst component(s) are combined in mole ratios of activator to catalyst component from 1000:1 to 0.1:1, and from 300:1 to 1:1 in another embodiment, and from 150:1 to 1:1 in yet another embodiment, and from 50:1 to 1:1 in yet another embodiment, and from 10:1 to 0.5:1 in yet another embodiment, and from 3:1 to 0.3:1 in yet another embodiment, wherein a desirable range may include any combination of any upper mole ratio limit with any lower mole ratio limit described herein. When the activator is a cyclic or oligomeric poly(hydrocarbylaluminum oxide) (e.g., “MAO”), the mole ratio of activator to catalyst component ranges from 2:1 to 100,000:1 in one embodiment, and from 10:1 to 10,000:1 in another embodiment, and from 50:1 to 2,000:1 in yet another embodiment. When the activator is a neutral or ionic ionizing activator such as a boron alkyl and the ionic salt of a boron alkyl, the mole ratio of activator to catalyst component ranges from 0.5:1 to 10:1 in one embodiment, and from 1:1 to 5:1 in yet another embodiment.

Supports

A support may also be present as part of the catalyst system of the invention. Supports (or “carriers”) are particularly useful in gas phase polyolefin polymerization processes. Supports, methods of supporting, modifying, and activating supports for single-site catalyst such as metallocenes is discussed in, for example, 1 METALLOCENE-BASED POLYOLEFINS 173-218 (J. Scheirs & W. Kaminsky eds., John Wiley & Sons, Ltd. 2000). The terms “support” or “carrier”, as used herein, are used interchangeably and refer to any support material, a porous support material in one embodiment, including inorganic or organic support materials. Non-limiting examples of support materials include inorganic oxides and inorganic chlorides, and in particular such materials as talc, clay, silica, alumina, magnesia, zirconia, iron oxides, boria, calcium oxide, zinc oxide, barium oxide, thoria, aluminum phosphate gel, and polymers such as polyvinylchloride and substituted polystyrene, functionalized or crosslinked organic supports such as polystyrene divinyl benzene polyolefins or polymeric compounds, and mixtures thereof, and graphite, in any of its various forms.

The support may be contacted with the other components of the catalyst system in any number of ways. In one embodiment, the support is contacted with the activator to form an association between the activator and support, or a “bound activator”. In another embodiment, the catalyst component may be contacted with the support to form a “bound catalyst component”. In yet another embodiment, the support may be contacted with the activator and catalyst component together, or with each partially in any order. The components may be contacted by any suitable means as in a solution, slurry, or solid form, or some combination thereof, and may be heated when contacted to from 25° C. to 250° C.

Desirable carriers are inorganic oxides that include Group 2, 3, 4, 5, 13 and 14 oxides and chlorides. Support materials include silica, alumina, silica-alumina, magnesium chloride, graphite, and mixtures thereof in one embodiment. Other useful supports include magnesia, titania, zirconia, montmorillonite (EP 0 511 665 B1), phyllosilicate, and the like. Also, combinations of these support materials may be used, for example, silica-chromium, silica-alumina, silica-titania and the like. Additional support materials may include those porous acrylic polymers described in EP 0 767 184 B1.

In one aspect of the support useful in the invention, the support possess a surface area in the range of from 10 to 700 m²/g, pore volume in the range of from 0.1 to 4.0 cm³/g and average particle size in the range of from 5 to 500 μm. In another embodiment, the surface area of the carrier is in the range of from 50 to 500 m²/g, pore volume of from 0.5 to 3.5 cm³/g and average particle size of from 10 to 200 μm. In yet another embodiment, the surface area of the carrier is in the range is from 100 to 400 m²/g, pore volume from 0.8 to 3.0 cm³/g and average particle size is from 5 to 100 μm. The average pore size of the carrier of the invention typically has pore size in the range of from 10 to 1000Å, from 50 to 500 Å in another embodiment, and from 75 to 350 Å in yet another embodiment.

In one embodiment of the support, graphite is used as the support. The graphite is a powder in one embodiment. In another embodiment, the graphite is flake graphite. In another embodiment, the graphite and has a particle size of from 1 to 500 microns, from 1 to 400 microns in another embodiment, and from 1 to 200 in yet another embodiment, and from 1 to 100 microns in yet another embodiment.

The support, especially an inorganic support or graphite support, may be pretreated such as by a halogenation process or other suitable process that, for example, associates a chemical species with the support either through chemical bonding, ionic interactions, or other physical or chemical interaction. In one embodiment, the support is fluorided. The fluorine compounds suitable for providing fluorine for the support are desirably inorganic fluorine containing compounds. Such inorganic fluorine containing compounds may be any compound containing a fluorine atom as long as it does not contain a carbon atom. Particularly desirable are inorganic fluorine containing compounds selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, NHF₂ and NH₄HF₂.

A desirable method of treating the support with the fluorine compound is to dry mix the two components by simply blending at a concentration of from 0.01 to 10.0 millimole F/g of support in one embodiment, and in the range of from 0.05 to 6.0 millimole F/g of support in another embodiment, and in the range of from 0.1 to 3.0 millimole F/g of support in yet another embodiment. The fluorine compound can be dry mixed with the support either before or after charging to the vessel for dehydration or calcining the support. Accordingly, the fluorine concentration present on the support is in the range of from 0.2 to 5 wt % in one embodiment, and from 0.6 to 3.5 wt % of support in another embodiment.

Another method of treating the support with the fluorine compound is to dissolve the fluorine in a solvent, such as water, and then contact the support with the fluorine containing solution (at the concentration ranges described herein). When water is used and silica is the support, it is desirable to use a quantity of water that is less than the total pore volume of the support. Desirably, the support and, for example, fluorine compounds are contacted by any suitable means such as by dry mixing or slurry mixing at a temperature of from 100° C. to 1000° C. in one embodiment, and from 200° C. to 800° C. in another embodiment, and from 300° C. to 600° C. in yet another embodiment, the contacting in any case taking place for between two to eight hours.

Dehydration or calcining of the support may or may also be carried out. In one embodiment, the support is calcined prior to reaction with the fluorine or other support-modifying compound. In another embodiment, the support is calcined and used without further modification, or calcined, followed by contacting with one or more activators and/or catalyst components. Suitable calcining temperatures range from 100° C. to 1000° C. in one embodiment, and from 300° C. to 900° C. in another embodiment, and from 400° C. to 850° C. in yet a more particular embodiment. Calcining may take place in the absence of oxygen and moisture by using, for example, an atmosphere of dry nitrogen.

It is within the scope of the present invention to co-contact (or “co-immobilize”) more than one catalyst component with a support. Non-limiting examples of co-immobilization of catalyst components include two or more of the same or different metallocene catalyst components, one or more metallocene with a Ziegler-Natta type catalyst, one or more metallocene with a chromium or “Phillips” type catalyst, one or more metallocenes with a Group 15 containing catalyst (e.g., zirconium bis-amide compounds such as in U.S. Pat. No. 6,300,438 B1), and any of these combinations with one or more activators. More particularly, co-supported combinations include metallocene A/metallocene A; metallocene A/metallocene B; metallocene/Ziegler Natta; metallocene/Group 15 containing catalyst; metallocene/chromium catalyst; metallocene/Ziegler Natta/Group 15 containing catalyst; metallocene/chromium catalyst/Group 15 containing catalyst, any of the these with an activator, and combinations thereof.

Further, the catalyst system of the present invention can include any combination of activators and catalyst components, either supported or not supported, in any number of ways. For example, the catalyst component may include any one or both of metallocenes and/or Group 15 containing catalysts components, and may include any combination of activators, any of which may be supported by any number of supports as described herein. Non-limiting examples of catalyst system combinations useful in the present invention include MN+NCA; MN:S+NCA; NCA:S+MN; MN:NCA:S; MN+AlA; MN:S+AlA; AlA:S+MN; MN:AlA:S; AlA:S+NCA+MN; NCA:S+MN+AlA; G15+NCA; G15:S+NCA; NCA:S+G15; G15:NCA:S; G15+AlA; G15:S+AlA; AlA:S+G15; G15:AlA:S; AlA:S+NCA+G15; NCA:S+G15+AlA; MN+NCA+G15; MN:S+NCA+G15; NCA:S+MN+G15; MN:NCA:S+G15; MN+G15+AlA; MN:S+AlA+G15; AlA:S+MN+G15; MN:AlA:S+G15; AlA:S+NCA+MN+G15; NCA:S+MN+AlA+G15; MN+NCA; G15:MN:S+NCA; G15:NCA:S+MN; G15:MN:NCA:S; G15:MN:S+AlA; G15:AlA:S+MN; G15:MN:AlA:S; G15:AlA:S+NCA+MN; G15:NCA:S+MN+AlA; wherein “MN” is metallocene component, “NCA” is a non-coordinating activator including ionic and neutral boron and aluminum based compounds as described above, “AlA” is an aluminum alkyl and/or alumoxane based activator, “G15” is a Group 15 containing catalyst component as described above, and “S” is a support; and wherein the use of “:” with “S” means that that those groups next to the colon are associated with (“supported by”) the support as by pretreatment and other techniques known in the art, and the “+” sign means that the additional component is not directly bound to the support but present with the support and species bound to the support, such as present in a slurry, solution, gas phase, or another way, but is not meant to be limited to species that have no physico-chemical interaction with the support and/or supported species. Thus, for example, the embodiment “MN:NCA:S+G15” means that a metallocene and NCA activator are bound to a support, and present in, for example, a gas phase polymerization with a Group 15 containing catalyst component.

Olefin Polymerization Using Tri-Bound Bridged Metallocenes

The catalyst system described above is suitable for use in any olefin prepolymerization and/or polymerization process over a wide range of temperatures and pressures and other conditions. Suitable polymerization processes include solution, gas phase, slurry phase and a high pressure process, or a combination thereof. A desirable process is a gas phase or slurry phase polymerization of one or more olefins at least one of which is ethylene or propylene, and more particularly, the process employed to polymerize olefins to form a polyolefin is a gas phase process under the conditions described herein.

The process of this invention is directed toward a solution, high pressure, slurry or gas phase polymerization process of one or more olefin monomers having from 2 to 30 carbon atoms, from 2 to 12 carbon atoms in another embodiment, and from 2 to 8 carbon atoms in yet another embodiment. The invention is particularly well suited to the polymerization of ethylene and at least one other olefin monomer selected from the group consisting of propylene, 1-butene, 1-pentene, 4-methyl-1-pentene, 1-hexene, 1-octene and 1-decene.

Other monomers useful in the process of the invention include ethylenically unsaturated monomers, diolefins having 4 to 18 carbon atoms, conjugated or nonconjugated dienes, polyenes, vinyl monomers and cyclic olefins. Non-limiting monomers useful in the invention may include norbornene, norbornadiene, isobutylene, isoprene, vinylbenzocyclobutane, styrenes, alkyl substituted styrene, ethylidene norbornene, dicyclopentadiene and cyclopentene.

In a desirable embodiment of the process of the invention, a copolymer of ethylene derived units is produced in a gas phase process, the comonomer comprising ethylene and α-olefin derived units having from 3 to 15 carbon atoms in one embodiment, and from 3 to 10 carbon atoms in another embodiment, and from 4 to 8 carbon atoms in yet another embodiment.

In another embodiment of the process of the invention, ethylene or propylene is polymerized with at least two different comonomers, optionally one of which may be a diene, to form a terpolymer.

In the production of polyethylene or polypropylene, comonomers may be present in the polymerization reactor. When present, the comonomer may be present at any level with the ethylene or propylene monomer that will achieve the desired weight percent incorporation of the comonomer into the finished resin. In one embodiment of polyethylene production, the comonomer is present with ethylene in a mole ratio range of from 0.0001 (comonomer:ethylene) to 50, and from 0.0001 to 5 in another embodiment, and from 0.0005 to 1.0 in yet another embodiment, and from 0.001 to 0.5 in yet another embodiment. Expressed in absolute terms, in making polyethylene, the amount of ethylene present in the polymerization reactor may range to up to 1000 atmospheres pressure in one embodiment, and up to 500 atmospheres pressure in another embodiment, and up to 200 atmospheres pressure in yet another embodiment, and up to 100 atmospheres in yet another embodiment, and up to 50 atmospheres in yet another embodiment.

The temperatures at which polymerization takes place (polymerization temperature) may be in the range of from −60° C. to 280° C. in one embodiment, and from 0° C. to 200° C. in another embodiment, and more particularly, from 20° C. to 180° C., and even more particularly from 30° C. to 160° C., and even more particularly from 40° C. to 150° C., and even more particularly from 50° C. to 120° C., and even more particularly from 60° C. to 100° C., wherein a desirable range can be any combination of any upper temperature limit with any lower temperature limit described herein. For purposes of this patent specification and appended claims the terms “polymerization temperature” and “reactor temperature” are interchangeable.

The reaction pressure, especially for a gas phase polymerization process, ranges from 20 psig (1.36 atm) to 1000 psig (68 atm) in one embodiment, and from 50 psig (3.4 atm) to 500 psig (34 atm) in another embodiment, and from 100 psig (6.8 atm) to 400 psig (27.2 atm) in yet a more particular embodiment.

Hydrogen gas is often used in olefin polymerization to control the final properties of the polyolefin, such as described in POLYPROPYLENE HANDBOOK 76-78 (Hanser Publishers, 1996). Using the catalyst system of the present invention, is known that increasing concentrations (partial pressures) of hydrogen increase the melt flow rate (MFR) and/or melt index (MI) of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and hexane or propylene. The amount of hydrogen used in the polymerization process of the present invention is an amount necessary to achieve the desired MFR or MI of the final polyolefin resin. In one embodiment, the mole ratio of hydrogen to total monomer (H₂:monomer) is in a range of from greater than 0.0001 in one embodiment, and from greater than 0.0005 in another embodiment, and from greater than 0.001 in yet another embodiment, and less than 50 in yet another embodiment, and less than 40 in yet another embodiment, and less than 30 in yet another embodiment, and less than 25 in yet another embodiment, wherein a desirable range may comprise any combination of any upper mole ratio limit with any lower mole ratio limit described herein. Expressed another way, the amount of hydrogen in the reactor at any time may range to up to 5000 ppm (molppm), and up to 4000 ppm in another embodiment, and up to 3000 ppm in yet another embodiment, and between 50 ppm and 5000 ppm in yet another embodiment, and between 200 ppm and 2000 ppm in another embodiment.

In another embodiment, the invention is directed to a polymerization process, particularly a gas phase or slurry phase process, for polymerizing propylene alone or with one or more other monomers including ethylene, and/or other olefins having from 4 to 12 carbon atoms. Polypropylene polymers may be produced using any suitable bridged metallocene-type catalysts such as described in, for example, U.S. Pat. No. 6,143,686, U.S. Pat. No. 6,143,911, U.S. Pat. No. 5,296,434 and U.S. Pat. No. 5,278,264.

Typically, in a gas phase polymerization process a continuous cycle is employed wherein one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer.

Further, it is common to use a staged reactor employing two or more reactors in series, wherein one reactor may produce, for example, a high molecular weight component and another reactor may produce a low molecular weight component. In one embodiment of the invention, the polyolefin is produced using a staged gas phase reactor. This and other commercial polymerization systems are described in, for example, 2 METALLOCENE-BASED POLYOLEFINS 366-378 (John Scheirs & W. Kaminsky, eds. John Wiley & Sons, Ltd. 2000). Examples of gas phase processes contemplated by the invention include those described in U.S. Pat. No. 5,627,242, U.S. Pat. No. 5,665,818 and U.S. Pat. No. 5,677,375; and EP-A- 0 794 200 EP-B1-0 649 992 , EP-A- 0 802 202 and EP-B- 634 421. The one or more reactors may be employed, independently, at a temperature or pressure as described above.

The gas phase reactor employing the catalyst system described herein is capable of producing from 100 lbs of polymer per hour (45.3 Kg/hr) to 200,000 lbs/hr (90,900 Kg/hr), and greater than 300 lbs/hr (136 Kg/hr) in another embodiment, and greater than 400 lbs/hr (181 Kg/hr).

Another desirable polymerization technique of the invention is referred to as a particle form polymerization, or a slurry process where the temperature is kept below the temperature at which the polymer goes into solution. Other slurry processes include those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484 and 2 METALLOCENE-BASED POLYOLEFINS 322-332 (2000).

In one embodiment of the process of the invention, the slurry or gas phase process is operated in the presence of a metallocene-type catalyst system of the invention and in the absence of, or essentially free of, any scavengers, such as triethylaluminum, trimethylaluminum, tri-isobutylaluminum and tri-n-hexylaluminum and diethyl aluminum chloride, dibutyl zinc and the like. By “essentially free”, it is meant that these compounds are not deliberately added to the reactor or any reactor components, and if present, are present to less than 1 ppm in the reactor.

In another embodiment, one or all of the catalysts are combined with up to 10 wt % of a metal stearate, (preferably a aluminum stearate, more preferably aluminum distearate) based upon the weight of the catalyst system (or its components), any support and the stearate. In an alternate embodiment, a solution of the metal stearate is fed into the reactor. In another embodiment, the metal stearate is mixed with the catalyst and fed into the reactor separately. These agents may be mixed with the catalyst or may be fed into the reactor in a solution or a slurry with or without the catalyst system or its components.

In another embodiment, the supported catalyst(s) are combined with the activators and are combined, such as by tumbling and other suitable means, with up to 2 wt % of an antistatic agent, such as a methoxylated amine, an example of which is Kemamine AS-990 (ICI Specialties, Bloomington Del.). Further, additives may be present such as carboxylate metal salts, as disclosed in U.S. Pat. No. 6,300,436.

Thus, the present invention includes a catalyst system and a method of polymerizing olefins using the catalyst system, the method comprising combining under polymerization conditions monomers selected from ethylene and C₃ to C₁₀ olefins; one or more activators; and one or more bridged metallocene catalyst components comprising two Cp groups and a trivalent bridging group (A); the group (A) comprising at least one A moiety, one A moiety in a particular embodiment, and at least three linkages, three linkages in a particular embodiment, between the A moiety and the two Cp ligands; wherein the Cp groups are independently selected from the group consisting of cyclopentadienyl, tetrahydroindenyl, indenyl, heterocyclic analogues thereof and substituted analogues thereof.

In another embodiment of the invention, the method of making polyolefins comprises combining under polymerization conditions monomers selected from ethylene and C₃ to C₁₀ olefins; one or more activators; a support; and one or more bridged metallocene catalyst components comprising two Cp groups and a trivalent bridging group (A); the group (A) comprising at least one A moiety, one A moiety in a particular embodiment, and at least three linkages, three linkages in a particular embodiment, between the A moiety and the two Cp ligands; wherein the Cp groups are independently selected from cyclopentadienyl, ligands isolobal to cyclopentadienyl, and substituted derivatives thereof. The metallocene catalyst compound may be bound to (supported) on the support either alone or with the activator.

In one embodiment, the A moiety is any moiety selected from Group 13, Group 14, Group 15 atoms, trivalent C₂ to C₁₆ hydrocarbons (e.g., trivalent cyclohexane, or C₆H₉³⁻), and trivalent C₂ to C₁₆ heteroatom-containing hydrocarbons (e.g., trivalent piperidine, or C₅H₁₁N³⁻), wherein the heteroatom is selected from phosphorous, nitrogen, oxygen, silicon, sulfur and boron in a particular embodiment, and wherein there are from 1 to 3 heteroatoms per heteroatom-containing hydrocarbon; and provided that if A is a Group 14 atom, the atom is also bound to a fourth group selected from C₁ to C₁₀ hydrocarbons and C₁ to C₁₀ heteroatom-containing hydrocarbons.

In a particular embodiment, the two Cps that make up the bridged metallocene catalyst component are cyclopentadienyl; and in another embodiment the two Cps are indenyls; and in yet another embodiment, the two Cps are cyclopentadienyl and indenyl; and in yet another embodiment, the two Cps are cyclopentadienyl and tetrahydroindenyl; and in yet another embodiment the two Cps are indenyl and tetrahydroindenyl; and in yet another embodiment the two Cps are cyclopentadienyl and fluorenyl; and in yet another embodiment the two Cps are fluorenyls; and in yet another embodiment the two Cps are fluorenyl and indenyl; and in yet another embodiment the two Cps are fluorenyl and tetrahydroindenyl, wherein any of the Cps may be substituted as described above (R⁴-R¹⁴ in structures IIIa and IIIb). In a particular embodiment, when the two Cps are fluorenyl and cyclopentadienyl, phenyl or other aryl or alkylaryl substituents are absent from the cyclopentadienyl.

The amount of activator, supported or not, and catalyst component used in the method of the invention is that required to obtain at least an activity of greater than 5,000 kg PE/mol Zr.hr, or 8,000 kg PE/mol Zr.hr at a polymerization temperature of from 30° C. to 100° C. in one embodiment using either slurry phase or gas phase conditions, gas phase conditions in a particular embodiment. The activity may vary depending upon the presence or absence of a support material, the type and amount of activator used, and the polymerization temperature, among other factors. In a particular embodiment, the activator is MAO supported on silica. The supported MAO may comprise from 1% to 40% by weight of Al (as part of the MAO) in one embodiment, and from 5% to 30% in another embodiment, and from 6% to 20% in yet a more particular embodiment. The weight ratio of metal (e.g., Zr) in the bridged metallocene to aluminum of MAO ranges from 1:5 to 1:100, and from 1:6 to 1:80 in a more particular embodiment, and from 1:8 to 1:60 in a more particular embodiment.

Thus, the compositions of the present invention can be described alternately by any of the embodiments disclosed herein, or a combination of any of the embodiments described herein. Embodiments of the invention, while not meant to be limiting by, may be better understood by reference to the following examples.

### EXAMPLES

All reactions were performed under nitrogen in dryboxes or connected to Schlenk lines unless stated otherwise. n-Butyl lithium (2.5M in hexanes), and solvents were purchased from Aldrich Chemical Company (Milwaukee, Wis.). 30 wt % methylaluminoxane in toluene was purchased from Albermarle (Baton Rouge, La.) and was used as received. Triisobutylaluminum was purchased from Alczo Nobel (Houston, Tex.) and was used as received. Zr(NMe₂)₄ was prepared by the method described by Jordan et al. (14 ORGANOMETALLICS 5 (1995)) and was also purchased from Strem Chemicals (Newburyport, Mass.). ClCH₂CH₂CH₂SiCl₂(CH₃) was purchased from Gelest (Morrisville, Pa.).

Desirable polymer products using the catalyst system of the invention include polyethylene and polypropylene homopolymer and copolymers, and polyethylene homopolymer and copolymers in a more particular embodiment. The polymers resulting from the methods of the present invention have a melt index (MI or I₂), measured according to ASTM D1238, Condition E at 190° C. with a load of 2.16 kg. Density of the polymers was measured according to ASTM D 1505. MIR (I₂₁/I₂) is the ratio of I₂₁ as described in ASTM-D-1238-F and I₂ as described in ASTM-D-1238-E. I₂ is well known in the art as the equivalent to Melt Index (MI). I₂₁ is also known as high load melt index (HLMI).

### Metallocene Synthesis Example 1

### (CH₂CH₂CH₂)CH₃Si(1,2-cyclopentadienyl)(1-cyclopentadienyl)ZrCl₂

15.8 grams of sodium cyclopentadienyl was combined with 12.1 grams of ClCH₂CH₂CH₂SiCl₂(CH₃) in diethyl ether. The reaction slurry was stirred for twelve hours at room temperature. 1 equivalent of n-butyl lithium (2.5M in hexanes) was added dropwise to the slurry. The solvent was removed, and tetrahydrofuran was added to the reaction mixture. The slurry was heated to 60 ° C. for three hours. The reaction was cooled to room temperature, combined with water and diethyl ether. The product was extracted with diethyl ether. The ether solution was dried over MgSO₄. The ether was removed and the resulting oil was short-path distilled (pot temp. 135° C.; distillation temp. 80° C., 500 mTorr). 3.0 grams product. The product, —CH₂CH₂CH₂-(cyclopentadiene)-Si(CH₃)(cyclopentadiene) (2.0 grams), was combined with Zr(NMe₂)₄ (1 equivalent) in dichloromethane (100 mL). The solution was stirred at room temperature for three hours. The solvent was concentrated removing HNMe₂. Trimethylsilylchloride was added in a 10-fold excess to the dichloromethane solution. After several hours a white precipitate forms. The precipitate was filtered and rinsed with dichloromethane cooled to −35° C. ¹H NMR (CD₂Cl₂); δ0.624 (s), 1.72 (m), 1.89 (s), 1.92 (s), 1.98 (s), 2.02 (2), 2.63 (s), 2.66 (s), 3.55(t), 5.64 (m), 6.49 (m).

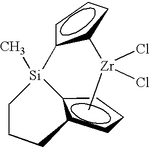

(CH₂CH₂CH₂)CH₃Si(1,2-cyclopentadienyl)(1-cyclopentadienyl)ZrCl₂

### Metallocene Synthesis Example 2

### (CH₂CH₂CH₂)CH₃Si(1,2-indenyl)(1-indenyl)ZrCl₂

Three equivalents of lithium indenide was combined with ClCH₂CH₂CH₂SiCl₂(CH₃) in diethyl ether at −35° C. (dropwise addition of ClCH₂CH₂CH₂SiCl₂(CH₃) ) and stirred for twelve hours at room temperature. Tetrahydrofuran was added to double the solvent volume and the solution was allowed to stir overnight at room temperature. A golden oil was obtained after a water/diethylether workup. The resulting oil was combined with Zr(NMe₂)₄ hexane and heated to reflux for twelve hours. The solvent was removed under vacuum and the resulting red oil was heated under vacuum at 135-140° C. for one day. Dichloromethane was added to dissolve product, which was then reacted with a large excess of trimethylsilylchloride and stirred overnight. A yellow crystalline product was obtained after cooling to −35° C. overnight. ¹H NMR (CD₂Cl₂); δ1.5, 2.1, 2.95, 5.96, 6.3, 6.8, 7.2, 7.35, 7.6, 7.85.

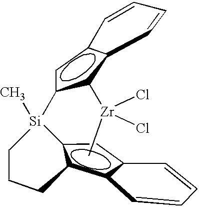

(CH₂CH₂CH₂)CH₃Si(1,2-indenyl)(1-indenyl)ZrCl₂

### Gas Phase Polymerization Example Employing Example 2 Metallocene

0.773 grams of (CH₂CH₂CH₂)CH₃Si(1,2-indenyl)(1-indenyl)ZrCl₂ from Example 2 was combined with 42.0 grams of supported methylaluminoxane (600° C. calcined silica, 12 wt % Al) yielding a toluene (180 mL) slurry. The slurry was filtered, rinsed with toluene, and the resulting supported catalyst was dried under vacuum overnight.

The polymerization was a gas phase polymerization in a fluidized bed reactor equipped with devices for temperature control, catalyst feeding or injection equipment, GC analyzer for monitoring and controlling monomer and gas feeds and equipment for polymer sampling and collecting. The reactor consists of a 6 inch (15.24 cm) diameter bed section increasing to 10 inches (25.4 cm) at the reactor top. Gas comes in through a perforated distributor plate allowing fluidization of the bed contents and polymer sample is discharged at the reactor top. The conditions and resulting polymer properties are outlined in Table 1. The activity of the catalyst system was 19,150 kg PE/mol Zr.hr.

The activity of the catalyst system of the invention under gas phase or slurry phase polymerization conditions, gas phase in a particular embodiment, employing the tri-bound bridged metallocenes described herein, is expected to range from greater than 5,000 kg PE/mol Zr.hr at a polymerization temperature of from 30° C. to 100° C., 10,000 kg PE/mol Zr.hr at from 30° C. to 100° C. in a more particular embodiment, and from greater than 14,000 kg PE/mol Zr.hr at from 30° C. to 100° C. in a more particular embodiment, and from greater than 16,000 kg PE/mol Zr.hr at from 30° C. to 100° C. in yet a more particular embodiment. In yet a more particular embodiment, the activity of the catalyst system of the invention is greater than 10,000 kg PE/mol Zr.hr at from 40° C. to 90° C., and from greater than 14,000 kg PE/mol Zr.hr at from 40° C. to 90° C. in a more particular embodiment, and from greater than 16,000 kg PE/mol Zr.hr at from 40° C. to 90° C. in yet a more particular embodiment. And in yet a more particular embodiment, the catalyst system of the invention is expected to have an activity of from greater than 10,000 kg PE/mol Zr.hr at from 60° C. to 90° C. Thus, the catalyst system of the present invention has an unexpectedly high activity compared to those of the prior art employing a tri-bound (or greater) bridged metallocene.

The melt index (MI) of the polyethylene copolymer products of the invention are from 1 to 100 dg/min in one embodiment, and from 2 to 80 in another embodiment; and the HLMI of the polyethylene copolymer products of the invention are from 100 to 2000 dg/min in one embodiment, and from 500 to 1000 dg/min in yet another embodiment. The density of the polyethylene copolymer products of the invention are from 0.880 to 0.930 g/cm³ in one embodiment, and from 0.900 to 0.928 g/cm³ in a more particular embodiment, and from 0.915 to 0.928 g/cm³ in yet a more particular embodiment.

The activity of the bridged metallocene catalyst system of the invention is surprising. Given that it is known in the art that metallocene activity tends to decrease upon being supported (See, e.g., METALORGANIC CATALYSTS FOR SYNTHESIS AND POLYMERIZATION 381-405 (Walter Kaminsky, ed. Springer-Verlag 1999)), the activity of the catalysts of the present invention might be expected to be lower than those reported for the tri-bound bridged (cyclopentadienyl-phenyl)(fluorenyl)zirconium compound discussed in the Background, as that compound was used unsupported in polymerizing propylene and ethylene. The catalyst system of the present invention thus demonstrates an unexpected advantage over the prior art in demonstrating relatively high polymerization activity.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the scope of the present invention. Further, certain features of the present invention are described in terms of a set of numerical upper limits and a set of numerical lower limits. It should be appreciated that ranges formed by any combination of these limits are within the scope of the invention unless otherwise indicated.

Unless otherwise indicated, all numbers expressing quantities of ingredients, properties, reaction conditions, and so forth, used in the specification and claims are to be understood as approximations based on the desired properties sought to be obtained by the present invention, and the error of measurement, etc., and should at least be construed in light of the number of reported significant digits and by applying ordinary rounding techniques. Notwithstanding that the numerical ranges and values setting forth the broad scope of the invention are approximations, the numerical values set forth are reported as precisely as possible.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 1
Catalyst A Polymerization

| Parameter | Value |
|---|---|
| H₂ conc. (molppm) | 670 |
| Hydrogen flow (sccm) | 0.00 |
| Comonomer cone. (mol %) | 0.32 |
| C₂ conc. (mol %) | 35.0 |
| Comonomer/C₂ Flow Ratio | 0.087 |
| C₂ flow (g/hr) | 545 |
| H₂/C₂ Ratio | 19.1 |
| Comonomer/C₂ ratio | 0.009 |
| Rxn. Pressure (psig) | 300 |
| Reactor Temp (° C.) | 80 |
| Avg. Bed weight (g) | 1965 |
| Production (g/hr) | 447 |
| Residence Time (hr) | 4.4 |
| C₂ Utilization (gC₂/gC₂ poly) | 1.22 |
| Avg. Velocity (ft/s) | 1.58 |
| Catalyst Timer (minutes) | 75.3 |
| Bulk Density (g/cm³) | 0.3275 |
| Product Data | |
| Melt Index (MI) (dg/min) | 39.40 |
| HLMI (dg/min) | 876.62 |
| HLMI/MI Ratio | 22.25 |
| Density (g/cm³) | 0.9232 |

What is claimed is:

1. A method of polymerizing olefins, the method comprising combining under polymerization conditions:
(a) monomers selected from ethylene and C₃ to C₁₀ olefins;
(b) an activator; and
(c) a bridged metallocene catalyst component comprising two Cp groups and a trivalent bridging group (A); the group (A) comprising at least one A moiety and at least three linkages between the A moiety and the two Cp ligands; wherein the Cp groups are independently selected from the group consisting of cyclopentadienyl, tetrahydroindenyl, indenyl, heterocyclic analogues thereof and substituted analogues thereof.

2. The method of claim 1, wherein the A moiety is a moiety selected from Group 13, Group 14, Group 15 atoms, trivalent C₂ to C₁₆ hydrocarbons, and trivalent C₂ to C₁₆ heteroatom-containing hydrocarbons.

3. The method of claim 1, wherein the A moiety is selected from Group 13, Group 14 and Group 15 atoms.

4. The method of claim 1, wherein the linkages are independently selected from chemical bonds, C₁ to C₆ alkylenes, C₄ to C₆ cycloalkylenes, C₂ to C₈ alkenylenes, C₁ to C₆ heteroatom-containing hydrocarbylenes.

5. The method of claim 1, wherein the trivalent bridging group (A) is described as: 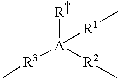
wherein A is a Group 14 atom;
R^{†} is selected from hydride, halogen radicals, C₁ to C₆ alkyls, C₆ to C₁₂ aryls, and C₁ to C₆ heteroatom-containing hydrocarbons; and
R¹, R² and R³ are divalent groups independently selected from chemical bonds, C₁ to C₆ alkylenes, C₄ to C₆ cycloalkylenes, C₂ to C₈ alkenylenes, and C₁ to C₆ heteroatom-containing hydrocarbylenes.

6. The method of claim 5, wherein R¹, R² and R³ are divalent groups independently selected from chemical bonds, methylene, ethylene, propylene, butylene, pentylene, hexylene, cyclopentylene and cyclohexylene.

7. The method of claim 1, wherein the bridged metallocene catalyst component is represented by the formula:
Cp^{A}(A)Cp^{B}MXₙ
wherein M is an atom selected from Group 3 through Group 12 metal atoms; each Cp^{A} and Cp^{B} are independently selected from substituted cyclopentadienyl or indenyl ligands, and unsubstituted cyclopentadienyl or indenyl ligands; each X is independently selected from any leaving group; n is an integer from 0 to 3; wherein each X, and Cp^{A} and Cp^{B} are chemically bonded to M;
wherein (A) comprises an A moiety and at least three linkages: at least two linkages between the A moiety and Cp^{A}, and one linkage between the A moiety and Cp^{B}, the linkages selected independently from covalent bonds, C₁ to C₁₂ hydrocarbylenes and C₁ to C₁₂ heteroatom-containing hydrocarbylenes; and
wherein the A moiety is selected from Group 13 atoms, Group 14 atoms, Group 15 atoms, trivalent C₂ to C₁₀ hydrocarbons, and trivalent C₂ to C₁₀ heteroatom-containing hydrocarbons.

8. The method of claim 1, wherein the monomers are ethylene and a monomer selected from the group consisting of C₃ to C₁₀ olefins.

9. The method of claim 8, wherein the mole ratio of ethylene to the monomer selected from the group consisting of C₃ to C₁₀ olefins is greater than 10:1.

10. The method of claim 1, wherein the polymerization is a gas phase polymerization.

11. The method of claim 1, wherein the polymerization is a slurry phase polymerization.

12. The method of claim 1, wherein the polymerization temperature ranges from 10° C. to 150° C.

13. The method of claim 1, wherein the polymerization temperature ranges from 40° C. to 120° C.

14. A method of polymerizing olefins, the method comprising combining under polymerization conditions:
(a) monomers selected from ethylene and C₃ to C₁₀ olefins;
(b) an activator;
(c) a support; and
(d) a bridged metallocene catalyst component comprising two Cp groups and a trivalent bridging group (A); the group (A) comprising at least one A moiety and at least three linkages between the A moiety and the two Cp ligands; wherein the Cp groups are independently selected from cyclopentadienyl, ligands isolobal to cyclopentadienyl, and substituted derivatives thereof.

15. The method of claim 14, wherein the A moiety is a moiety selected from Group 13, Group 14, Group 15 atoms, trivalent C₂ to C₁₆ hydrocarbons, and trivalent C₂ to C₁₆heteroatom-containing hydrocarbons.

16. The method of claim 14, wherein the A moiety is selected from Group 13, Group 14 and Group 15 atoms.

17. The method of claim 14, wherein the linkages are independently selected from chemical bonds, C₁ to C₆ alkylenes, C₄ to C₆ cycloalkylenes, C₂ to C₈ alkenylenes, C₁ to C₆ heteroatom-containing hydrocarbylenes.

18. The method of claim 14, wherein the trivalent bridging group (A) is described as: 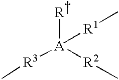
wherein A is a Group 14 atom;
R^{†} is selected from hydride, halogen radicals, C₁ to C₆ alkyls, C₆ to C₁₂ aryls, and C₁ to C₆ heteroatom-containing hydrocarbons; and
R¹, R² and R³ are divalent groups independently selected from chemical bonds, C₁ to C₆ alkylenes, C₄ to C₆ cycloalkylenes, C₂ to C₈ alkenylenes, and C₁ to C₆ heteroatom-containing hydrocarbylenes.

19. The method of claim 18, wherein R¹, R² and R³ are divalent groups independently selected from chemical bonds, methylene, ethylene, propylene, butylene, pentylene, hexylene, cyclopentylene and cyclohexylene.

20. The method of claim 14, wherein the bridged metallocene compound is bound to the support.

21. The method of claim 20, wherein the activator is bound to the support.

22. The method of claim 14, wherein the monomers are ethylene and a monomer selected from the group consisting of C₃ to C₁₀ olefins.

23. The method of claim 22, wherein the mole ratio of ethylene to the monomer selected from the group consisting of C₃ to C₁₀ olefins is greater than 10:1.

24. The method of claim 14, wherein the polymerization is a gas phase polymerization.

25. The method of claim 14, wherein the polymerization is a slurry phase polymerization.

26. The method of claim 14, wherein the polymerization temperature ranges from 10° C to 150° C.

27. The method of claim 14, wherein the polymerization temperature ranges from 40° C. to 120° C.

28. A catalyst system for producing polyolefins comprising an activator; a support; and a bridged metallocene catalyst component comprising two Cp groups and a trivalent bridging group (A); the group (A) comprising at least one A moiety and at least three linkages between the A moiety and the two Cp ligands; wherein the Cp groups are independently selected from cyclopentadienyl, ligands isolobal to cyclopentadienyl, and substituted derivatives thereof.

29. The catalyst system of claim 28, wherein the A moiety is a moiety selected from Group 13, Group 14, Group 15 atoms, trivalent C₂ to C₁₆ hydrocarbons, and trivalent C₂ to C₁₆ heteroatom-containing hydrocarbons.

30. The catalyst system of claim 28, wherein the A moiety is selected from Group 13, Group 14 and Group 15 atoms.

31. The catalyst system of claim 28, wherein the linkages are independently selected from chemical bonds, C₁ to C₆ alkylenes, C₄ to C₆ cycloalkylenes, C₂ to C₈ alkenylenes, C₁ to C₆ heteroatom-containing hydrocarbylenes.

32. The catalyst system of claim 28, wherein the trivalent bridging group (A) is described as: 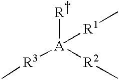
wherein A is a Group 14 atom;
R^{†} is selected from hydride, halogen radicals, C₁ to C₆ alkyls, C₆ to C₁₂ aryls, and C₁ to C₆ heteroatom-containing hydrocarbons; and
R¹, R² and R³ are divalent groups independently selected from chemical bonds, C₁ to C₆ alkylenes, C₄ to C₆ cycloalkylenes, C₂ to C₈ alkenylenes, and C₁ to C₆ heteroatom-containing hydrocarbylenes.

33. The catalyst system of claim 32, wherein R¹, R² and R³ are divalent groups independently selected from chemical bonds, methylene, ethylene, propylene, butylene, pentylene, hexylene, cyclopentylene and cyclohexylene.

34. The catalyst system of claim 28, wherein the bridged metallocene catalyst component is represented by the formula:
Cp^{A}(A)Cp^{B}MXₙ
wherein M is an atom selected from Group 3 through Group 12 metal atoms; each Cp^{A} and Cp^{B} are independently selected from substituted cyclopentadienyl or indenyl ligands, and unsubstituted cyclopentadienyl or indenyl ligands; each X is independently selected from any leaving group; n is an integer from 0 to 3; wherein each X, and Cp^{A} and Cp^{B} are chemically bonded to M;
wherein (A) comprises an A moiety and at least three linkages: at least two linkages between the A moiety and Cp^{A}, and one linkage between the A moiety and Cp^{B}, the linkages selected independently from covalent bonds, C₁ to C₁₂ hydrocarbylenes and C₁ to C₁₂ heteroatom-containing hydrocarbylenes; and
wherein the A moiety is selected from Group 13 atoms, Group 14 atoms, Group 15 atoms, trivalent C₂ to C₁₀ hydrocarbons, and trivalent C₂ to C₁₀ heteroatom-containing hydrocarbons.

35. The catalyst system of claim 28, also comprising a support.

36. The catalyst system of claim 35, wherein the support is pretreated with the activator to produce a supported activator.

37. A catalyst system for producing polyolefins comprising an activator; and a bridged metallocene catalyst component comprising two Cp groups and a trivalent bridging group (A); the group (A) comprising at least one A moiety and at least three linkages between the A moiety and the two Cp ligands; wherein the Cp groups are independently selected from the group consisting of cyclopentadienyl, tetrahydroindenyl, indenyl, heterocyclic analogues thereof and substituted analogues thereof.

38. The catalyst system of claim 37, wherein the A moiety is a moiety selected from Group 13, Group 14, Group 15 atoms, trivalent C₂ to C₁₆ hydrocarbons, and trivalent C₂ to C₁₆ heteroatom-containing hydrocarbons.

39. The catalyst system of claim 37, wherein the A moiety is selected from Group 13, Group 14 and Group 15 atoms.

40. The catalyst system of claim 37, wherein the linkages are independently selected from chemical bonds, C₁ to C₆ alkylenes, C₄ to C₆ cycloalkylenes, C₂ to C₈ alkenylenes, C₁ to C₆ heteroatom-containing hydrocarbylenes.

41. The catalyst system of claim 37, wherein the trivalent bridging group (A) is described as: 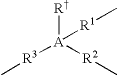
wherein A is a Group 14 atom;
R^{†} is selected from hydride, halogen radicals, C₁ to C₆ alkyls, C₆ to C₁₂ aryls, and C₁ to C₆ heteroatom-containing hydrocarbons; and
R¹, R² and R³ are divalent groups independently selected from chemical bonds, C₁ to C₆ alkylenes, C₄ to C₆ cycloalkylenes, C₂ to C₈ alkenylenes, and C₁ to C₆ heteroatom-containing hydrocarbylenes.

42. The catalyst system of claim 41, wherein R¹, R² and R³ are divalent groups independently selected from chemical bonds, methylene, ethylene, propylene, butylene, pentylene, hexylene, cyclopentylene and cyclohexylene.

43. The catalyst system of claim 37, wherein the bridged metallocene catalyst component is represented by the formula:
Cp^{A}(A)Cp^{B}MXₙ
wherein M is an atom selected from Group 3 through Group 12 metal atoms; each Cp^{A} and Cp^{B} are independently selected from substituted cyclopentadienyl or indenyl ligands, and unsubstituted cyclopentadienyl or indenyl ligands; each X is independently selected from any leaving group; n is an integer from 0 to 3; wherein each X, and Cp^{A} and Cp^{B} are chemically bonded to M;
wherein (A) comprises an A moiety and at least three linkages: at least two linkages between the A moiety and Cp^{A}, and one linkage between the A moiety and Cp^{B}, the linkages selected independently from covalent bonds, C₁ to C₁₂ hydrocarbylenes and C₁ to C₁₂ heteroatom-containing hydrocarbylenes; and
wherein the A moiety is selected from Group 13 atoms, Group 14 atoms, Group 15 atoms, trivalent C₂ to C₁₀ hydrocarbons, and trivalent C₂ to C₁₀ heteroatom-containing hydrocarbons.

44. The catalyst system of claim 37, wherein the support is pretreated with the activator to produce a supported activator.
